(19) United States
(12) Patent Application Publication
(10) Pub. No.: US 2026/0116127 A1
(43) Pub. Date: Apr. 30, 2026

(54) A TREAD BAND FOR A PNEUMATIC TYRE AND TYRE COMPRISING THE SAME

(71) Applicant: BRIDGESTONE EUROPE NV/SA, ZAVENTEM (BE)

(72) Inventors: Salvatore COTUGNO, Roma (IT); Enrico FRESCH, Roma (IT); Cecilia ANGELOSANTO, Roma (IT); Giuseppe ARNONE, Roma (IT); Marco DEL DUCA, Roma (IT); Antonio TIRONE, Roma (IT)

(21) Appl. No.: 19/141,860

(22) PCT Filed: Dec. 22, 2022
(86) PCT No.: PCT/EP2022/087580

§ 371 Date: Jun. 20, 2025

(51) Int. Cl. B60C 1/00; B60C 11/00; B60C 11/12; C08K 3/36; C08K 9/04; C08L 15/00

(52) U.S. Cl. CPC B60C 1/0016; B60C 11/0008; B60C 11/1218; C08K 3/36; C08K 9/04; C08L 15/00; B60C 2011/0025; B60C 2011/1213; C08K 2201/006; C08L 2205/025; C08L 2205/035

(57) ABSTRACT

A tread band for a pneumatic tyre and tyre comprising the same, wherein the tread band has transversal sipes and comprises a first and second hydrocarbon polymer resin additive.

### FIELD OF THE INVENTION

The present invention relates to a tread band for a pneumatic tyre and tyre comprising the same, wherein the tread band comprises a first and second hydrocarbon polymer resin additive, which, in combination with the presence of transversal sipes in the tread band, has a beneficial and/or synergistic impact on the wet performance, rolling resistance, and wear resistance of tyres comprising the tread band.

### BACKGROUND TO THE INVENTION

There is a demand for vehicles with lower fuel consumption in order to reduce CO₂ emissions, which can be achieved by reducing the rolling resistance of the vehicle's tyres. It is also important for tyres to have a good grip performance, especially on wet road surfaces (i.e. wet performance). A high wear resistance is also an important factor for a long service life of the tyre. Together, the wet performance (“WET”), rolling resistance (“RR”), and wear resistance (“WEAR”) are known as the ‘magic triangle’ of viscoelastic properties. There is an ongoing need to produce tyres having an improved balance between these properties.

The chemical composition of tyres may be modified to adjust their dynamic/mechanical properties. In an attempt to achieve a better WET/RR/WEAR balance, the use of modified rubbers, mixtures of rubbers and various reinforcing fillers has been proposed. However, improving any one of these properties of the tyre often has an adverse impact on at least one of the other properties. For example, it is difficult to improve the wet performance of a tyre without adversely affecting its rolling resistance and wear resistance. Similarly an increase in the amount of reinforcing filler results in improved wear performance, this reduces the rolling resistance.

Hydrocarbon resins are widely used as processing aids that can also be used to modify the viscoelastic properties of rubber compositions and thus to enhance tyre tread performance properties, for example wet grip and rolling resistance. A wide range of hydrocarbon resins are known for use in the production of rubber compositions for tyre treads, including aliphatic resins, aromatic resins, partially and fully hydrogenated resins. Combinations of different hydrocarbon resins have been proposed. In US 2019/0092937, for example, blends of a C₅ aliphatic resin with a dicyclopentadiene (DCPD) resin or aromatic pure monomer resin are proposed for tuning the material properties of an immiscible blend of natural rubber and a high-cis polybutadiene rubber.

The physical form of the tyre tread, in particular the size and shape of the portion that contacts the road surface (the contact patch), also impacts its performance. Tyre treads are commonly cut to form tread elements. Circumferential grooves in the tread can improve water removal (and thus impact wet performance) while lateral grooves can improve traction and wear resistance. Sipes are small grooves that are cut laterally across larger tread elements and are known to improve traction in wet conditions and to reduce wear. There remains a need in the art for tyre treads in which the chemical composition and physical form are optimised in tandem to improve tyre performance.

The present invention aims to meet the unmet needs of the art and solve problems associated with existing tyres.

### SUMMARY OF THE INVENTION

The present invention is based on the discovery that optimising the chemical composition and the physical form of a tread band can have beneficial and/or synergistic effect on the properties of a tyre prepared from the tread band. The present invention thus provides a tread band comprising a first and second hydrocarbon polymer resin and having transversal sipes, which together improve tyre performance compared to tyres prepared either without the sipes of the present invention or without the hydrocarbon polymer resins of the present invention.

Viewed from a first aspect, the present invention is a tread band for a tyre suitable for engaging a road surface at a footprint area comprising:
two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib,
   wherein the central elements are separated along their entire axial width by transversal sipes, the transversal sipes defining two endpoints at their respective axially outer ends where they intersect the circumferential grooves; and, wherein the tread band further comprises:
(i) a first hydrocarbon polymer additive which is a partially hydrogenated C₅ resin; and,
(ii) a second hydrocarbon polymer additive which is a fully hydrogenated resin selected from the group consisting of a hydrogenated C₅ resin, a hydrogenated C₅/C₉ copolymer resin, a hydrogenated C₉ resin, and combinations thereof.

Viewed from a second aspect, the present invention is a pneumatic tyre comprising the tread band according to the first aspect.

Further advantageous features of the invention are described herein.

### BRIEF DESCRIPTION OF THE FIGURES

FIG. 1 is a perspective view of the tyre of the preferred embodiment of the invention;

FIG. 2 is a front elevation view of the tyre of FIG. 1;

FIG. 3 is a fragmentary front view of the tyre of FIG. 1; and

FIG. 4 is a schematic view of a transversal sipe forming portion of a mould for the tyre of FIG. 1.

FIG. 5 is a schematic view of a first alternative sipe-forming mould for forming a first alternative transversal sipe having a projection in a central region of the base of the sipe, which is rounded at its base and top edge and projects partially upwards from the base of the sipe.

FIG. 6 is a schematic view of a second alternative sipe-forming mould for forming a second alternative transversal sipe having a series of raised ellipses arranged linearly along the length of the sipe.

FIG. 7 is a schematic view of a third alternative sipe-forming mould for forming a third alternative transversal sipe having a longitudinal sinusoidal feature at the base of the sipe.

### DETAILED DESCRIPTION OF THE INVENTION

The present invention provides a tread band for a tyre suitable for engaging a road surface at a footprint area comprising:
two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib,
   wherein the central elements are separated along their entire axial width by transversal sipes, the transversal sipes defining two endpoints at their respective axially outer ends where they intersect the circumferential grooves; and,
wherein the tread band comprises:
(i) a first hydrocarbon polymer additive which is a partially hydrogenated C₅ resin; and,
(ii) a second hydrocarbon polymer additive which is a fully hydrogenated resin selected from the group consisting of a hydrogenated C₅ resin, a hydrogenated C₅/C₉ copolymer resin, a hydrogenated C₉ resin, and combinations thereof.

The present inventors have discovered that combining the physical features of the tread band with the hydrocarbon polymer additives provides improved wet performance (“WET”), rolling resistance (“RR”), and wear resistance (“WEAR”) and better balance between these properties compared to tread bands having different physical features and/or that do not contain the hydrocarbon polymer additives. The beneficial effect of combining the physical features of the tread band with the hydrocarbon polymer additives may be a synergistic effect.

### Hydrocarbon Polymer Additive Component

The tread bands herein described include a hydrocarbon polymer additive component and may be formed from or prepared from compositions comprising the hydrocarbon polymer additive component. As used herein, the term “hydrocarbon polymer additive” refers to a hydrocarbon resin and is used interchangeably herein with the term “hydrocarbon resin”. The hydrocarbon polymer additive component comprises a first hydrocarbon polymer additive which is a partially hydrogenated C₅ resin; and a second hydrocarbon polymer additive which is a fully hydrogenated resin selected from a hydrogenated C₅ resin, a hydrogenated C₅/C₉ copolymer resin, a hydrogenated C₉ resin, and combinations thereof. Additional resins may be present, but in one embodiment the only resins present are the first and second hydrocarbon resins as herein described. Exemplary combinations of the first and second hydrocarbon polymer additives include a partially hydrogenated C₅ resin and a fully hydrogenated C₅ resin; a partially hydrogenated C₅ resin and a fully hydrogenated C₅/C₉ copolymer resin; a partially hydrogenated C₅ resin and a fully hydrogenated C₉ resin. A preferred combination of hydrocarbon polymer additives for use in the invention is a partially hydrogenated C₅ resin and a fully hydrogenated C₉ resin.

As used herein, the term “hydrogenated resin” refers to a resin obtained by subjecting a resin to reductive hydrogenation. Hydrogenation may be partial, thus giving rise to a “partially hydrogenated resin” or it may be substantially complete thereby producing a “fully hydrogenated” resin.

As used herein, the term “partially hydrogenated” means that the resin component contains less than 100% olefinic protons, which may be determined by ¹H NMR spectroscopy. Partially hydrogenated resins are well known in the art and may have different degrees of hydrogenation. In some embodiments, the partially hydrogenated resin may contain less than 95% olefinic protons, more preferably less than 90% olefinic protons. In some embodiments, it may contain less than 75% olefinic protons, for example less than 50% olefinic protons. In some embodiments, the partially hydrogenated resin may contain less than 40% olefinic protons, less than 25% olefinic protons, less than 15% olefinic protons, or less than 10% olefinic protons. For example, it may contain less than 9%, less than 8%, less than 7%, or less than 6% olefinic protons. In one embodiment, the partially hydrogenated resin may contain about 5% or more olefinic protons. For example, it may contain from 5% to 90% olefinic protons. In one embodiment, the partially hydrogenated resin may contain about 5% olefinic protons, i.e. it will be about 95% hydrogenated.

As used herein, the term “fully hydrogenated” means that the resin component contains less than 5% olefinic protons. In some embodiments, the fully hydrogenated resin may contain less than 4% olefinic protons, preferably less than 3%, more preferably less than 2%, e.g. less than 1%, less than 0.5%, or less than 0.1%, e.g. less than 0.05%. In one embodiment, the fully hydrogenated resin may contain from 0 to about 3% olefinic protons, i.e. it will be about 97 to 100% hydrogenated. In one embodiment, the fully hydrogenated resin may contain from 0 to about 2% olefinic protons, i.e. it will be about 98 to 100% hydrogenated. In one embodiment, the fully hydrogenated resin may contain from 0 to about 1% olefinic protons, i.e. it will be about 99 to 100% hydrogenated. In one embodiment, it may contain about 0% olefinic protons.

Hydrogenated resins include resins produced by reductive hydrogenation of resins that include aromatic components. As will be understood, any reference herein to olefinic protons is intended to include any protons that may be present as part of an aromatic ring system. The percentages listed herein in respect of the content of olefinic protons and degree of hydrogenation refer to mol. %.

For any selected combination of hydrocarbon resins for use in the invention, the extent of hydrogenation of the “fully hydrogenated” resin will be greater than that of the “partially hydrogenated” resin, i.e. the “fully hydrogenated” resin will have a lower content of olefinic protons than the “partially hydrogenated” resin. Advantageously, the difference in degree of hydrogenation of the different hydrocarbon resins for use in the invention may be small. For example, the mol. % olefinic proton content of the different resins may differ by less than 10 mol. %, for example less than 8 mol. %, less than 7 mol. %, less than 6 mol. %, less than 5 mol. %, less than 4 mol. % or less than 3 mol. %. In one embodiment, it may differ by 1 mol. % to 10 mol. %, e.g. by 1 mol. % to 5 mol. %.

The first hydrocarbon polymer additive is a partially hydrogenated C₅ resin. As used herein, the term “C₅ resin” refers to a resin obtained by polymerisation of a cracked naphtha feed that contains C₅ monomers. C₅ monomers include olefins, linear conjugated diolefins and cyclic conjugated diolefins. Other monomers may additionally be present in the feed and these include, but are not limited to, dicyclopentadiene (DCPD).

In one embodiment, the C₅ resin for use in the invention may be obtained by co-polymerisation of C₅ monomers and dicyclopentadiene (DCPD) monomers. Where any DCPD monomers are present, these will generally be provided in low amounts. For example, the content of DCPD in the feed used to produce the resin may be less than about 5 wt. %, e.g. less than about 2 wt. %. Preferably, the C₅ resin may comprise monomer units derived from C₅ monomers and from DCPD. As such the partially hydrogenated C₅ resin may comprise a partially hydrogenated C₅ and dicyclopentadiene (DCPD) copolymer, preferably wherein DCPD is present in an amount of less than 5 wt % of the C₅ and DCPD monomers. However, in another embodiment, the feed used to provide the C₅ resin may exclude any DCPD monomer. This monomer can be removed from the feed stream by methods generally known in the art. In one embodiment, the C₅ resin may therefore consist essentially of monomer units derived from C₅ monomers.

In order to improve wet performance, the hydrogenated C₅ resin for use in the invention will have a high softening point, for example a softening point higher than 110° C. As used herein, the term “softening point” refers to the temperature at which a resin flows. The softening point of a resin can be measured by the ring and ball method. Unless otherwise specified, any softening point listed herein is the “ring and ball softening point”, i.e. it is the temperature at which a balls falls in the measurement of the softening point using a ring and ball softening point measuring apparatus in accordance with ASTM D 3461-76. In certain embodiments, the softening point of the hydrogenated C₅ resin is 110° C. or higher, 115° C. or higher, preferably 118° C. or higher, more preferably 121° C. or higher, e.g. 123° C. or higher. For example, it may be 125° C. or higher. From the perspective of suppressing an increase in tan δ at 0° C., a softening point of the hydrogenated C₅ resin is preferably 145° C. or lower. For example, the softening point may be 143° C. or lower, 140° C. or lower, 136° C. or lower, 135° C. or lower. For example, the softening point of the hydrogenated C₅ resin may be from 115° C. to 145° C., more preferably from 120° C. to 140° C., more preferably from 125° C. to 135° C., for example 125, 126, 127, 128, 129, 230, 131, 132, 133, 134, or 135° C.

From the perspective of miscibility of the resin, the weight average molecular weight of the partially hydrogenated C₅ resin will generally be in the range from 200 to 2000 g/mol. Unless otherwise specified, any reference herein to molecular weight refers to the weight average molecular weight, Mw. The weight average molecular weight is determined by gel permeation chromatography (GPC) relative to polystyrene standards. In some embodiments, the weight average molecular weight of the partially hydrogenated C₅ resin may be 300 g/mol or higher, preferably 600 g/mol or higher, more preferably 800 g/mol or higher. In other embodiments, the weight average molecular weight of the partially hydrogenated C₅ resin may be 2000 g/mol or lower, preferably 1800 g/mol or lower, more preferably 1600 mol/g or lower, yet more preferably 1400 g/mol or lower. For example, the weight average molecular weight of the partially hydrogenated C₅ resin may be from 600 g/mol to 1600 g/mol, more preferably from 800 g/mol to 1400 g/mol, more preferably 1000 g/mol to 1200 g/mol, for example 1000, 1100, or 1200 g/mol.

The glass transition temperature (T₉) of the partially hydrogenated C₅ resin may be 50° C. or higher, preferably from 60° C. to 90° C., more preferably from 65° C. to 85° C. T₉ values reported herein are determined using differential scanning calorimetry (DSC), starting temperature: −140° C.; temperature ramp: 15° C./min. Unless otherwise specified, all test methods herein described are conducted at 23° C. and 50% relative humidity.

The partially hydrogenated C₅ resin for use in the invention is a resin produced by subjecting a C₅ resin as herein described to partial reductive hydrogenation. Examples of the C₅ resin include aliphatic petroleum resins obtained by (co)-polymerizing a C₅ fraction obtained by pyrolysis of naphtha in the petrochemical industry. The C₅ fraction normally contains olefin-based hydrocarbons, such as 1-pentene, 2-pentene, 2-methyl-1-butene, 2-methyl-2-butene, and 3-methyl-1-butene; di-olefin-based hydrocarbons, such as 2-methyl-1,3-butadiene, 1,2-pentadiene, 1,3-pentadiene, and 3-methyl-1,2-butadiene. As herein described, the C₅ fraction may additionally contain other monomers such as dicyclopentadiene (DCPD). Where DCPD is present, it will generally be present in low amounts, for example in an amount of less than 5 wt. %, e.g. less than 2 wt. % of the C₅-containing fraction. Any of these resins may be subjected to partial reductive hydrogenation to produce a partially hydrogenated C₅ resin, for example one that contains from 3 to 9% olefinic protons, preferably from 4 to 8% olefinic protons, more preferably from 4 to 6% olefinic protons. In one embodiment, the partially hydrogenated C₅ resin contains about 5% olefinic protons. Any commercially available product may be employed as the partially hydrogenated C₅ resin.

In preferred embodiments, the partially hydrogenated C₅ resin may have one or more of the following features:
an olefinic proton content of less than 10 mol. %, preferably from 2 mol. % to 8 mol. %;
a softening point 110° C. or higher, preferably from 120° C. to 140° C.;
a weight average molecular weight of from 200 g/mol to 2000 g/mol, preferably from 800 g/mol to 1400 g/mol. In this embodiment, the partially hydrogenated C₅ resin may have a glass transition temperature (T₉) of 50° C. or higher, preferably from 60° C. to 90° C.; and/or,
the partially hydrogenated C₅ resin may comprise a partially hydrogenated C₅ and dicyclopentadiene (DCPD) copolymer, preferably wherein DCPD is present in an amount of less than 5 wt % of the C₅ and DCPD monomers.

The second hydrocarbon polymer additive is selected from a fully hydrogenated C₅ resin, a fully hydrogenated C₅/C₉ copolymer resin, a fully hydrogenated C₉ resin, and combinations thereof. In a preferred embodiment, the second hydrocarbon polymer additive is a fully hydrogenated C₉ resin.

In order to improve wet performance, the second hydrocarbon resin for use in the invention will have a high softening point, for example a softening point higher than 100° C. In certain embodiments, the softening point of the second hydrocarbon resin is 110° C. or higher, preferably 115° C. or higher, preferably 118° C. or higher. From the perspective of suppressing an increase in tan δ at 0° C., the softening point of the second hydrocarbon resin is preferably 145° C. or lower. For example, the softening point may be 143° C. or lower, 140° C. or lower, 136° C. or lower, 135° C. or lower, 133° C. or lower, or 130° C. or lower. For example, the softening point of the second hydrocarbon resin may be from 100° C. to 145° C., preferably from 110° C. to 135° C., more preferably from 115° C. to 130° C., for example, 115, 116, 117, 118, 119, 120, 121, 122, 123, 124, 125, 126, 127, 128, 129, or 130° C.

From the perspective of miscibility of the resin, the weight average molecular weight of the second hydrocarbon resin will generally be in the range from 700 to 1500 g/mol. In some embodiments, the weight average molecular weight of the second resin may be 800 g/mol or higher, preferably 900 g/mol or higher, more preferably 1000 g/mol or higher. In other embodiments, the weight average molecular weight of the second hydrocarbon resin may be 1400 g/mol or lower, preferably 1300 g/mol or lower, more preferably 1200 mol/g or lower. In one embodiment, the second hydrocarbon resin will have a softening point higher than 100° C. and a weight average molecular weight of 700 to 1500 g/mol. More preferably, the second hydrocarbon resin will be a fully hydrogenated C₉ resin having a softening point higher than 100° C. and a weight average molecular weight of 700 to 1500 g/mol. The second hydrocarbon resin is one produced by subjecting a resin to substantially complete (e.g. complete) reductive hydrogenation.

The glass transition temperature (T₉) of the hydrogenated C₉ resin may be 50° C. or higher, preferably from 55° C. to 85° C., more preferably from 60° C. to 80° C.

The resin used as the starting material is selected from C₅ resins, C₅/C₉ resins, C₉ resins and combinations thereof. Examples of the C₅ resin which may be used to produce a fully hydrogenated C₅ resin include aliphatic petroleum resins obtained by (co)-polymerizing a C₅ fraction obtained by pyrolysis of naphtha in the petrochemical industry. The C₅ fraction normally contains olefin-based hydrocarbons, such as 1-pentene, 2-pentene, 2-methyl-1-butene, 2-methyl-2-butene, and 3-methyl-1-butene; di-olefin-based hydrocarbons, such as 2-methyl-1,3-butadiene, 1,2-pentadiene, 1,3-pentadiene, and 3-methyl-1,2-butadiene. It may also contain other monomers, for example DCPD. Any commercially available product may be employed as the C₅ resin.

The term “C₅/C₉ resin” refers to a C₅-C₉ synthetic petroleum resin, and examples include a petroleum derived C₅-C₁ fraction including AlCl₃; solid polymers obtained by polymerization using a Friedel-Crafts catalyst such as BF₃, and more specific examples thereof include copolymers containing styrene, vinyl toluene, α-methyl styrene, indene, or the like as main components. From the perspective of compatibility with the rubber component, a resin having a small amount of C₉ or greater components is preferable as the C₅/C₉ resin. For example, the amount of C₉ or greater components may be less than 50 wt. %, and preferably less than 40 wt. %, based on the total amount of the resin. Any commercially available product can be used as the C₅/C₉ resin.

The term “C₉ resin” refers to a C₉ synthetic petroleum resin and examples include a polymer obtained by polymerization using a Friedel-Crafts catalyst such as AlCl₃ or BF₃. Examples of the C₉ resin include a copolymer containing indene, styrene, α-methyl styrene, vinyl toluene, or the like as main components.

The olefinic proton content of the first and second hydrocarbon polymer additives may differ by less than 10 mol. %. The second hydrocarbon polymer additive may contain from 0 to about 3 mol. % olefinic protons, e.g. 0 mol. % olefinic protons. The second hydrocarbon polymer additive may have a weight average molecular weight of from about 700 g/mol to about 1500 g/mol, and/or a softening point greater than 100° C.

In preferred embodiments, the hydrogenated C₉ resin may have one or more of the following features:
a softening point of 100° C. or higher, preferably from 110° C. to 135° C.;
a weight average molecular weight (Mw) of from 700 g/mol to 1500 g/mol; and/or,
a glass transition temperature (T₉) of at least 50° C., preferably from 60° C. to 80° C.

In preferred embodiments, the tread band comprises a first hydrocarbon polymer additive which is a partially hydrogenated C₅ resin and a second hydrocarbon polymer additive which is a fully hydrogenated C₉ resin each having the features of the preferred embodiments of the partially hydrogenated C₅ resin and the fully hydrogenated C₉ resin described hereinabove.

In order to improve dispersion of the components, the tread band may comprise the first hydrocarbon polymer additive in an amount of from 1 to 30 phr, preferably from 5 to 10 phr, for example 5, 6, 7, 8, 9 or 10 phr. The tread band may comprise the second hydrocarbon polymer additive in an amount of from 1 to 30 phr, preferably from 5 to 10 phr, for example 5, 6, 7, 8, 9, or 10 phr. The tread band comprises the first hydrocarbon polymer additive and the second hydrocarbon polymer additive in a total amount of from 2 to 60 phr, more preferably from 10 to 20 phr, for example 10, 11, 12, 13, 14, 15, 16, 17, 18, 19 or 20 phr. Unless otherwise specified, the term “phr” means parts per hundred parts of rubber (by weight). It is a term commonly used in the art in which the components of a composition are measured relative to the total of all rubber (i.e. elastomer) components. The total parts of the rubber components are defined as 100 phr and all other components are defined as a ratio against the 100 parts of rubber and expressed in “phr”. The ratio of the amount of the first hydrocarbon polymer additive to the second hydrocarbon polymer additive may be from 10:1 to 1:10, preferably from 5:1 to 1:5, more preferably from 2:1 to 1:2, more preferably 1:1.

To further improve dispersion of the components, and thus improve the performance of the tyre, the tread band may comprise the first hydrocarbon polymer additive, which is a partially hydrogenated C₅ resin having the features of the preferred embodiments of the partially hydrogenated C₅ resin described hereinabove, in an amount of from 6 to 10 phr, and the second hydrocarbon polymer additive, which is a fully hydrogenated C₉ resin having the features of the preferred embodiments of the hydrogenated C₉ resin described hereinabove, in an amount of from 6 to 10 phr, wherein the ratio of the amount of the first hydrocarbon polymer additive to the second hydrocarbon polymer additive is 1:1.

### Elastomer Component

The tread band of the present invention may comprise one or more elastomer components. The tread band may also be formed from, prepared from or prepared using a rubber composition comprising one or more elastomer components. The rubber composition may be a vulcanisable rubber composition, which may be vulcanised.

Styrene butadiene rubber (SBR) is commonly used in the tyre industry and can be made by well-known methods, such as by co-polymerisation of the corresponding monomers in emulsion, suspension or in solution. In one set of embodiments, the styrene butadiene copolymer for use in the invention may be a solution-polymerised styrene butadiene rubber (SSBR) or an emulsion-polymerised styrene butadiene rubber (ESBR). By “emulsion-polymerised styrene butadiene rubber” is meant that styrene and 1,3-butadiene are copolymerised as an aqueous emulsion. Such a method is well known and understood by those skilled in the art.

In the present invention, the tread band may comprise and/or be prepared from a first elastomer component comprising one or more styrene butadiene copolymers. Preferably, the first elastomer component may comprise a first styrene butadiene copolymer and a second styrene butadiene copolymer.

In some embodiments, the styrene content of the first SBR copolymer may be from 10 wt. % to 40 wt. % (by weight of the first SBR copolymer), preferably 10 wt. % to 30 wt. % by weight, more preferably 15 wt. % to 25 wt. %, yet more preferably 21 wt. % to 24 wt. %, e.g. about 21 wt. %. Styrene content may be determined by ¹H-NMR.

The first styrene butadiene copolymer may preferably be an end-group functionalised copolymer that may have an interactive and/or synergistic impact on the properties of the tread bands and give rise to advantageous properties. Specifically, when a silica filler system is present, an interaction between the end-group functionalised styrene butadiene copolymer and silica, which may be synergistic, may result in improved dispersion of the filler system in the rubber compositions and products made therefrom. An “end-group functionalised” SBR may also be referred to as a “terminal-modified” SBR. In some embodiments, the styrene butadiene copolymer may be an end-group functionalised SSBR. Preferably, the first styrene-butadiene copolymer is functionalised with terminal carboxyl groups. The end-group functionalised SSBR copolymer was prepared according to Example 3 of WO 2014/173706 A1, as described below.

An inertized 20 litre reactor was charged with hexane (8.5 kg), 1,3-butadiene (1,185 g), styrene (315 g), 2,2-bis(2-tetrahydrofuryl)propane (8.6 mmol) and butyllithium (11.3 mmol), and the contents were heated to 60° C. Polymerization was effected while stirring at 60° C. for 25 minutes. Subsequently, an amount of hexamethylcyclotrisiloxane equimolar to that of butyllithium was added (as a solution in cyclohexane) and the reactor contents were then heated to 60° C. for a further 20 minutes to cap the anionic ends of the polymer chains. 20 minutes after addition of the hexamethylcyclotrisiloxane, an amount of 2,2-dimethyl-1-oxa-4-thia-2-silacyclohexan-6-one equimolar to that of butyllithium and hexamethylcyclotrisiloxane was added (as a solution in toluene) and the mixture was heated to 60° C. for a further 20 minutes. The rubber solution was discharged and stabilized by addition of Irganox® 1520 (2,4-bis(octyllithiomethyl)-6-methylphenol) (3 g), and the solvent was removed by stripping with steam. The rubber crumbs were dried at 65° C. under reduced pressure.

The first styrene-butadiene copolymer may have a vinyl content of from 50 to 75% by weight, preferably 58 to 68% by weight, for example, 58, 59, 60, 61, 62, 63, 64, 65, 66, 67 or 68% by weight.

The first styrene-butadiene copolymer may have a glass transition temperature, Tg, ranging from −40 to −15° C., preferably −30 to −20° C., for example −30, −29, −28, −27, −26, −25, −24, −23, −22, −21, −20° C.

The first styrene-butadiene copolymer may have an oil content of from 0.5 to 10 parts per hundred parts of the first styrene-butadiene copolymer, for example 5 parts per hundred parts of the first styrene-butadiene copolymer.

Wherein the tread band comprises the first styrene-butadiene copolymer in an amount of at least 30 phr, more preferably 40 to 70 phr, more preferably 50 to 65 phr, for example 50, 51, 52, 53, 54, 55, 56, 57, 58, 59, 60, 61, 62, 63, 64, or 65 phr.

The second styrene-butadiene copolymer may have a styrene content of from 25 to 50% by weight of the second SBR copolymer, preferably from 32 to 42% by weight, for example, 33, 34, 35, 36, 37, 38, 39, 40, 41 or 42% by weight.

The second styrene-butadiene copolymer may have a vinyl content of from 45 to 70% by weight, preferably 52 to 62% by weight, for example 52, 53, 54, 55, 56, 57, 58, 59, 60, 61, or 62% by weight.

The second styrene-butadiene copolymer may be oil extended and thus may have an oil content of from 10 to 35 parts per hundred parts of the second styrene-butadiene copolymer, preferably 20 to 30 parts per hundred of the second styrene-butadiene copolymer.

The second styrene-butadiene copolymer may has a glass transition temperature, Tg, ranging from −40 to −10° C., preferably −25 to −15° C. for example −25, −24, −23, −22, −21, −20° C., −19° C., −18° C., −17° C., −16° C., −15° C.

The tread band may comprise the second styrene-butadiene copolymer in an amount of at least 10 phr, more preferably 15 to 35 phr, more preferably 20 to 30 phr, for example 20, 21, 22, 23, 24, 25, 26, 27, 28, 29, or 30 phr.

The tread band may further comprise a second elastomer component comprising natural rubber. Natural rubber is well known for use in the manufacture of tyres. The natural rubber for use in the invention is not particularly limited and may be any natural rubber or combination of natural rubbers commonly used in the tyre industry. Particular examples include Standard Malaysian Rubber (SMR), Standard Indonesian Rubber (SIR), Specified Singapore Rubber (SSR), Standard Lanka Rubber (SLR), Thai Tested Rubber (TTR), and Nigerian Standard Rubber (NSR).

The tread band may comprise the natural rubber in an amount of at least 5 phr, more preferably 10 to 30 phr, more preferably 15 to 25 phr, for example 15, 16, 17, 18, 19, 20, 21, 22, 23, 24, or 25 phr.

Other rubber components that may be present include butadiene rubber (BR), ethylene propylene diene monomer rubber (EPDM), butyl rubber (IIR), polyisobutylene rubber, epoxidized natural rubber (ENR), neoprene, synthetic polyisoprene (IR), and polyurethane.

### Reinforcing Fillers

The tread band of the present invention may comprise one or more reinforcing filler components. The tread band may be formed from, prepared from or prepared using a rubber composition comprising one or more reinforcing filler components. Reinforcing filler components may, for example, be selected from silica, carbon black, carbon nanotubes, short carbon, polyamide, polyester, natural fibres, calcium carbonate, clay, alumina, aluminosilicates, and any mixtures thereof. The use of silica, carbon black and blends of silica and carbon black are generally preferred.

The term “silica filler” as used herein refers to particulate silica. Any known type of particulate silica capable of reinforcing a styrene butadiene rubber-based composition may be used. As will be understood, known silica materials typically contain a proportion of other components (e.g. as impurities), but the main component will be silicon dioxide, i.e. SiO₂. The content of silicon dioxide will generally be at least 90 wt. %, preferably at least 95 wt. %, e.g. at least 97 wt. %. Silica materials for use in the invention may be precipitated amorphous silica, wet silica (hydrated silicic acid), dry silica (anhydrous silicic acid), fumed silica, calcium silicate, aluminium silicate, magnesium silicate (e.g. Mg₂SiO₄, MgSiO₃), magnesium calcium silicate (CaMgSiO₄), and aluminium calcium silicate (e.g. Al₂O₃·CaO₂SiO₂). A single silica or combination of two or more types of silica may be used. The silica is used in the form of discrete particles, i.e. as a granulate which is highly dispersible.

The silicas may preferably be selected according to its specific surface area. The surface area of the functionalised silicas described herein were measured by the CTAB method according to ASTM D6845 and/or by the BET method according to the method described in the Journal of the American Chemical Society, Vol. 60, page 309, February 1938, and corresponding to standard NF ISO 5794-1, Appendix D (June 2010). The tread band may comprise a first silica having a very high surface area. That is, the first silica may have a CTAB specific surface area of from 230 to 285 m²/g, preferably 240 to 270 m²/g and/or a BET surface area of from 260 to 310 m²/g, preferably 270 to 300 m²/g. Advantageously, the first silica may be a funtionalised very high surface area silica, which is functionalised at its surface with one or more carboxyl groups. The carboxyl groups may be present as carboxylic acids and/or as derivatives thereof such as salts or esters. The functionalised silicas may be prepared according to Example 6 in WO 2015/121333 A1, wherein the amount of methylglutaric acid (MGA) added was 0.40 wt % (expressed as MGA mixture/SiO₂ weight ratio) and the pH was adjusted to be between 3 and 4.2. The tread band may comprise the first silica in an amount of at least 40 phr, more preferably 50 to 80 phr, more preferably from 60 to 70 phr, for example 60, 61, 62, 63, 64, 65, 66, 67, 68, 69 or 70 phr.

The tread band may comprise a second silica. The second silica may have a very low surface area. That is, the second silica may have a CTAB specific surface area of 60 to 100 m²/g, preferably 65 to 95 m²/g, and/or a BET surface area of from 60 to 120 m²/g, preferably 70 to 110 m²/g. The tread band may comprise the second silica in an amount of 1 to 30 phr, more preferably 5 to 25 phr, more preferably 10 to 20 phr, for example 10, 11, 12, 13, 14, 15, 16, 17, 18, 19 or 20 phr.

It is particularly advantageous for the tread band of the present invention to comprise a first silica, which is the functionalised very high surface area silica described above, and a second silica, which is the very low surface area silica described above, wherein the amount of the first silica is present in an amount of from 60 to 70 phr and the second silica is present in an amount of from 10 to 20 phr.

In a particular embodiment, the tread band comprises:
two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib, wherein the central elements are separated along their entire axial width by transversal sipes, the transversal sipes defining two endpoints at their respective axially outer ends where they intersect the circumferential grooves; and,
wherein the tread band comprises,
a hydrocarbon polymer additive component comprising:
   (i) a first hydrocarbon polymer additive, which is a partially hydrogenated C₅ resin, in an amount of from 1 to 30 phr; and,
   (ii) a second hydrocarbon polymer additive which is a fully hydrogenated C₉ resin, in an amount of from 1 to 30 phr;
   wherein the ratio of the amount of the first hydrocarbon polymer additive to the second hydrocarbon polymer additive is from 2:1 to 1:2, preferably 1:1.
a first styrene butadiene copolymer, which is functionalised with terminal carboxyl groups has a styrene content of from 21% to 24% by weight of the first styrene butadiene copolymer and is present in an amount of from 50 to 65 phr;
a second styrene butadiene copolymer having a styrene content of from 32 to 42% by weight of the second styrene butadiene copolymer and is present in an amount of from 20 to 30 phr;
a first silica functionalised at its surface with one or more carboxyl groups and having a CTAB specific surface area of from 240 to 270 m²/g and/or a BET surface area of from 270 to 300 m²/g, present in an amount of from 60 to 70 phr; and,
a second silica having a CTAB specific surface area of from 65 to 95 m²/g, and/or a BET surface area of from 70 to 110 m²/g, present in an amount of from 10 to 20 phr.

### Additional Components

Tread bands in accordance with the invention may be made from or prepared from or prepared using rubber compositions using methods known in the art in the manufacture of rubber compositions, such as compounding with other components. These further components can include additional polymers, additional processing aids (such as oils, waxes, and plasticisers), curing systems (such as vulcanising agents, vulcanisation accelerators, and vulcanisation accelerator auxiliaries), anti-degradants (such as antioxidants or antiozonants), pigments, fillers (such as silica and/or carbon black fillers as herein described), compatibilising agents for the fillers (such as silane coupling agents or covering agents as herein described), fibres, etc.

Processing aids improve the processability of the compositions and include oils, such as mineral oils, vegetable oils, synthetic oils, or any mixtures thereof. These may be used in an amount of from about 5 to 75 phr (including the amount of any oil that may be used to extend the polymers), preferably from about 10 to 50 phr. Typical processing aids include oils, such as aromatic oils. Examples of such oils include Treated Distillate Aromatic Extract (TDAE), Residual Aromatic Extract (RAE), Mild Extract Solvate (MES), and bio-based oil seed derivatives. For example, the oil may be one or more selected from the group consisting of processed oils such as aromatic oils, naphthenic oils and paraffin oils, vegetable oils such as coconut oil, synthetic oils such as alkylbenzene oils and castor oils. Preferably, the oil is an aromatic oil, such as a residual aromatic extract oil.

The vulcanising agent is not particularly limited and may be any of those generally known in the art. For example, the vulcanising agent may be sulfur. The amount of the vulcanising agent is not particularly limited, and an amount effective to achieve a satisfactory cure of the composition may readily be selected by those skilled in the art. The vulcanising agent (e.g. sulfur) may be used in an amount in the range from about 0.1 to about 10 phr, preferably from about 0.1 to about 5 phr, e.g. from about 0.2 to about 3 phr. For example, the rubber composition may contain from 0.3 to 2 phr, preferably from 0.5 to 1.5 phr, e.g. from 0.5 to 1 phr, of the vulcanising agent.

The vulcanisation accelerator is not particularly limited and may be any of those generally known in the art. Accelerators include thiazoles, dithiocarbamates, thiurams, guanidines, and sulphonamides. Preferably, the vulcanisation accelerator may be a combination of dibenzothiazyl disulfide (MBTS), N-cyclohexyl-2-benzothiazyl sulfenamide (CBS), and 1,3-diphenyl guanidine (DPG). The amount of vulcanisation accelerator for use in the compositions is not particularly limited and may, for example, be in the range from about 0.5 to about 10 phr, preferably from about 1 to about 8 phr, more preferably from about 2 to about 6 phr. Preferably, the vulcanisation accelerator may comprise dibenzothiazyl disulfide (MBTS) in an amount from 1 to 2 phr, N-cyclohexyl-2-benzothiazyl sulfenamide (CBS) in an amount from 0.5 to 2 phr, and 1,3-diphenyl guanidine (DPG) in an amount of 1 to 3 phr.

The vulcanisation accelerator auxiliary is not particularly limited and may be any of those known to the person skilled in the art. For example, the vulcanisation accelerator auxiliary may be zinc oxide (ZnO) and a fatty acid. Preferably the vulcanisation accelerator auxiliary of the present invention is zinc oxide (ZnO) and stearic acid. The total amount of the vulcanisation accelerator auxiliary is not particularly limited, but may be from 1 to 10 phr, preferably from 1.5 to 7 phr, for example, from 2 to 5 phr. Preferably, zinc oxide may be used in an amount of from about 1 to about 10 phr, preferably from about 2 to about 5 phr, more preferably from about 2 to about 3 phr. Stearic acid may be used in an amount of from about 1 to about 5 phr, preferably from about 1.5 to about 3 phr.

Coupling agents which bind to the silanol groups of silica in order to inhibit the agglomeration thereof and which also function to covalently link the silica fillers to the styrene butadiene copolymer may be present. Typically, the coupling agent will be a silane coupling agent, for example a bifunctional silane. Preferably, the silane coupling agent is bis(3-triethoxysilylpropyl) tetrasulfide. A specific example of the silane coupling agent for use in the invention is Si 69® from Evonik Industries AG. The amount of the silane coupling agent is not particularly limited, but may be from 2 to 20 phr, preferably from 5 to 18 phr, more preferably from 7 to 16 phr, for example from 9 to 15 phr.

The tread bands according to the invention may be prepared by methods known in the art and will involve mixing (i.e. compounding) of the elastomers, the hydrocarbon polymer additive component, and any other components herein described to produce a rubber composition for subsequent vulcanization.

According to a further aspect, the present invention provides a method of producing a tread band comprising the steps of: compounding the rubber composition as herein described to form a rubber compound; forming (e.g. moulding) the rubber compound into a desired shape; and vulcanising the rubber compound. The method may further comprise steps of forming (for example by cutting) one or more circumferential grooves, lateral grooves, and/or sipes to form tread features as will be described hereinbelow.

In preparing the tread band of the invention, the method for combining each of the components in the rubber composition from which is it prepared is not limited and any of the methods known in the art may be used. For moulding the rubber composition into any desired shape, any known moulding machine such as an extrusion moulding machine or press moulding machine may be used. Mixing of the components will usually be carried out in stages in which the components may be added. Multi-step mixing processes are generally preferred to optimize dispersion of the silica filler system and may involve the use of more than one mixer, for example different mixers arranged in series. For example, in the case of mixing a tyre tread compound, the mixing process may involve an initial mixing stage in which a masterbatch is produced, followed by one or more additional non-productive mixing stages, and finally a productive mixing stage in which the curative agents (i.e. sulfur or sulfur-donating agents and accelerator(s)) are added. Mixers which may be used are well known in the art and include, for example, an open mill or a Banbury type mixer having tangential or intermeshing rotors.

Typically, the first and second elastomers, the hydrocarbon polymer additive component, fillers (where present), additional processing aids (where present), zinc oxide, stearic acid, anti-degradants (e.g. anti-oxidants, anti-ozonants), pigments, compatibilising agents, and coupling agents (where present) are mixed to produce the initial masterbatch. This initial masterbatch may be followed by a non-productive mixing stage in which no additional components are added. Any non-productive mixing stage may be used to further disperse the components (e.g. fillers) within the rubber, or to decrease the viscosity of the mixed rubber compound. During mixing, the temperature is kept below a predetermined level to avoid premature cross-linking of the composition. Typically, the temperature may be kept below 150° C., preferably below 140° C. In producing the initial masterbatch, mixing may for example be carried out a temperature of from about 80 to about 110° C., e.g. about 100° C. In the non-productive mixing stage the temperature may be raised, for example up to about 150° C., e.g. about 130° C. If any additional compatibilising agents are added during mixing, it may be necessary to carry out mixing at higher temperatures to ensure that these react with the silica surface (where any silica fillers is present). Mixing times may vary but can readily be determined by those skilled in the art based on the composition of the mixture and the type of mixer used. Generally a mixing time of at least 1 minute, preferably between 2 and 30 minutes, should be sufficient to obtain the desired homogenous composition. A final mixing stage involves the addition of curatives, including accelerator(s), anti-degradants. The temperature for this mixing stage will generally be lower, for example in the range of from about 40 to about 60° C., e.g. about 50° C. This final mix may also be followed by a further non-productive mixing stage in which no additional components are added. The most appropriate type of mixing can readily be selected to achieve a vulcanizable rubber compound. Mixing speeds may readily be determined, but may for example range from a speed of from about 20 to about 100 rpm, e.g. from about 30 to about 80 rpm, preferably about 50 rpm. Curing to cross-link the rubber components may be carried out by known methods. In the tyre industry, for example, an uncured rubber (so-called “green body”) is produced followed by curing in a press mold which concurrently cross-links the rubber components and molds the components into a final tyre. vulcanisation cures the rubber by cross-linking, principally via sulfur cross-links. Vulcanisation methods and conditions for hardening the rubber composition are well known to those skilled in the art. Appropriate vulcanization conditions typically include heating to a temperature in the range from 120 to 200° C., e.g. from 140 to 180° C., for a duration of from 5 to 180 mins, e.g. from 5 to 120 mins.

### Tread Band Features

According to the present invention, the central elements are separated along their entire axial width by transversal sipes, the transversal sipes defining two endpoints at their respective axially outer ends where they intersect the circumferential grooves. These features increase cornering performance and circumferential stiffness (and hence traction and braking performance). In combination with the hydrocarbon polymer additive component as described herein above, an additional beneficial and/or synergistic impact is seen on the wet performance, wear resistance and rolling resistance, as well as the balance between these properties.

Preferably, an imaginary straight extension line between the two endpoints defines an inclination angle of the transversal sipe with respect to the axial direction of the tyre whose absolute value lies in the range of 25° to 50°, more preferably in the range of 25° to 45°, more preferably in the range of 30° to 40°. The absolute value may be about 35°. The sipe is arranged in this way to improve lateral and circumferential connection of the central elements, which results in increased cornering performance and circumferential stiffness. Also, since the sipe is inclined, it moves into the contact patch of the tyre gradually, in a progressive way, and not over the whole length of the sipe at the same time. This reduces the noise emissions.

Preferably, the imaginary straight extension lines of the transversal sipes in the two rows of central elements are inclined respectively in the opposite direction. This is done to balance the direction and magnitude of transversal force.

Preferably, an extension of the transversal sipes along the axial direction between the two endpoints of the transversal sipes is non-linear. The sipe is arranged in this way to improve lateral and circumferential connection of the central elements, which results in increased cornering performance and circumferential stiffness.

Preferably, the extension along the axial direction between the two endpoints of the transversal sipes is substantially S-shaped. The sipe is arranged in this way to improve lateral and circumferential connection of the central elements, which results in increased cornering performance and circumferential stiffness. This arrangement can also reduce tyre noise by leading to more progressive block impact with the road surface.

Preferably, an undulated profile is superimposed on the S-shaped extension along the axial direction of the transversal sipes. This is the result of the transversal sipes having a three-dimensional shape. (The undulated profile may be visible on the tread surface, or the undulated profile may end a certain distance below the tread surface inside the tread.) This gives a local contact area boost which leads to improved braking; it can also lead to local wear reduction.

Preferably, the transversal sipes have a total length along their extension between the two endpoints and the total length of the transversal sipe having an undulated profile superimposed to the S-shaped extension is at least 20% greater than a transversal sipe extending along a straight line between the two endpoints. This gives the sipe a minimum degree of performance improvement in comparison to a sipe that follows a straight line between the endpoints.

As the undulated profile along the axial direction extends in the radial direction (i.e. in the depth direction of the sipe), another undulated profile may be superimposed on the extension in the radial direction. In this way, the profile is undulated in two directions. Therefore, when a first block moves in the radial direction, it comes into contact with its adjacent second block on the other side of the sipe, which limits the movement of the first block in the radial direction. This increases the above effects of the axial undulated profile further.

Preferably, each endpoint of a transversal sipe of each row of central elements has an offset in the circumferential direction with respect to each circumferential direction closest endpoint of a transversal sipe of the adjacent row or rows. In this way, the endpoints in adjacent rows are not aligned along the tyre axial direction. This leads to reduced tyre noise. Impacts of different endpoints onto the road surface are arranged so that they do not happen all at the same time; if the impact of all endpoints occurred at the same time, the result would be disturbing noise generation.

Preferably, each of the endpoints is offset in the circumferential direction with respect to each circumferential direction closest endpoint of a transversal sipe of each of the rows.

Preferably, the transversal sipes have a radial extension inside the tread band along a radial profile, wherein the radial profile is undulated or zig-zag shaped as the sipes extend in the axial direction.

Preferably, in the footprint area the width in the axial direction of each of the shoulder elements is greater than the width in axial direction of each of the central elements, and wherein over the whole circumference of the tyre the total number of shoulder elements in each row is greater than the total number of central elements in each row. This helps to balance stiffness at the shoulder with stiffness at the centre of the tyre, and to avoid rib “fighting”, and so reduce tyre wear. This arrangement can also reduce tyre noise by reducing synchronization of the impact of the central and shoulder elements with the road surface.

Preferably, the total number of shoulder elements in each row is at most 125% of the total number of central elements in each row, preferably at most 120%, more preferably about 115%.

Preferably, the total number of shoulder elements in each row is at least 110% of the total number of central elements in each row.

In one preferred form, the central elements are void of incisions, and preferably are only separated by the transversal sipes.

Preferably, the shoulder elements are separated by lugs extending substantially in the axial direction of the tyre, and the lugs have a width in the circumferential direction and have along their longitudinal extension a first portion intersecting a circumferential groove and a second portion extending outwards in the axial direction of the tyre

Preferably, the width of the lugs in the first portion intersecting the circumferential groove is smaller than the width of the lugs in the second portion. This helps to reduce the noise produced by impact of the shoulder elements or blocks on the road surface. More specifically this helps to reduce the so called air pumping in the lug generating noise emissions. The tyre noise may be measured using a pass-by noise test. Conversely, the fact that the lugs intersect a circumferential groove means that the adjacent blocks can move with respect to each other as they exit the contact patch of the tyre with the road surface, which leads to wear performance improvement.

Preferably, the width of the first portion is in the range of one-twelfth to one-eighth of the width of the second portion. This helps to reduce the so called air pumping in the lug generating noise emissions.

The width of the first portion may be about 0.4 mm.

Preferably, the sidewalls of the first portion are configured to touch each other when the first portion passes through the contact patch of the tyre with the road surface. In this way, the first portion is closed when it is in the contact patch, which helps to reduce the noise produced by impact of the blocks on the road surface. Conversely, when the blocks are exiting the contact patch, the first portion allows the adjacent blocks to move with respect to each other, which leads to wear performance improvement.

Preferably, the intersection between a lug and a circumferential groove has an offset in the circumferential direction with respect to each circumferential direction closest endpoint of a transversal sipe of each row of the central elements. This arrangement can reduce tyre noise by reducing synchronization of the impact of the central and shoulder elements with the road surface.

Preferably, a lug in each shoulder area is arranged in this way.

In one preferred form, the shoulder elements are void of incisions, and preferably are only separated by the lugs.

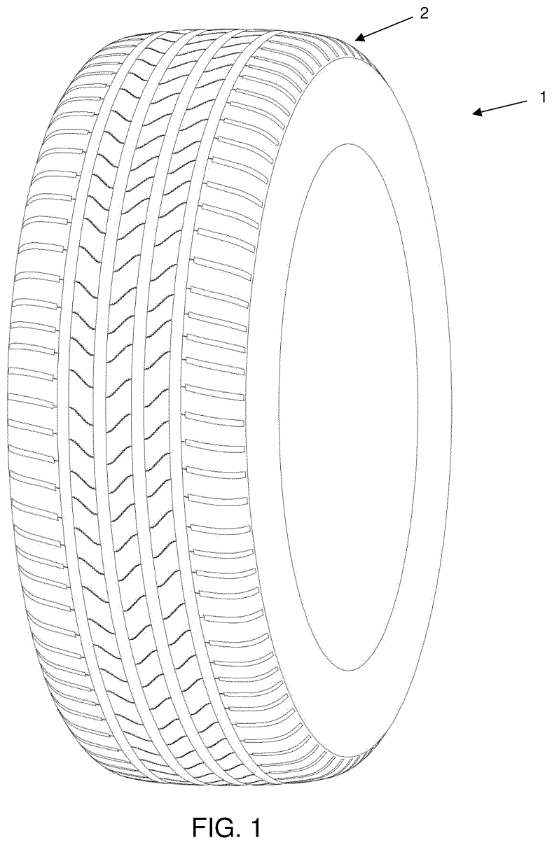

Referring to FIGS. 1 to 3, a pneumatic tyre 1 is shown. The tyre 1 has a tread band 2 for engaging a road surface at a footprint area of the tyre 1.

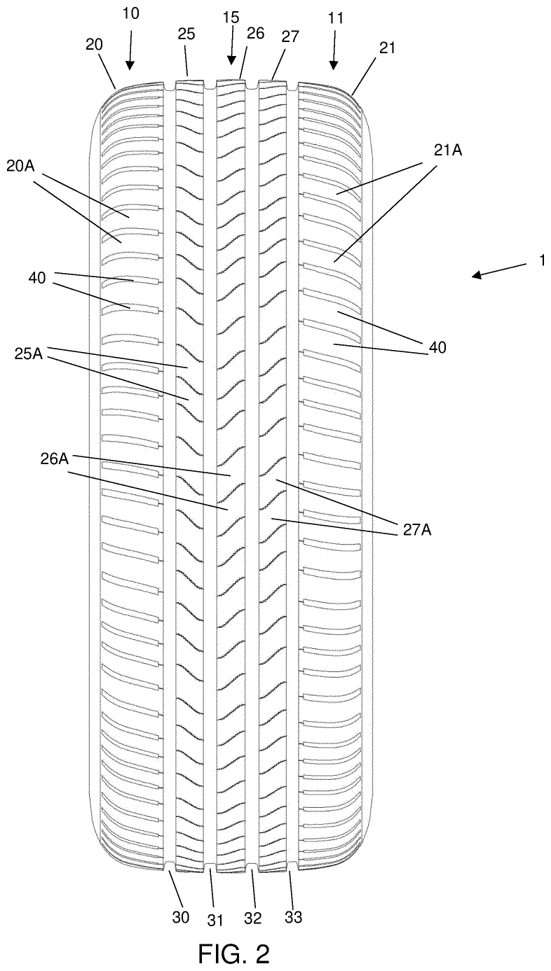

As best seen in FIG. 2, the tread band 2 has two shoulder areas 10, 11 at the axially outer ends of the tread band 2, and a central area 15 identified between the shoulder areas 10, 11. The central area includes the tyre equatorial plane.

In each of the shoulder areas 10, 11 is a shoulder (first) circumferential rib 20, 21 which extends along the circumferential direction of the tyre 1. Also in each of the shoulder areas 10, 11 is a row of shoulder elements or blocks 20A, 21A arranged along the shoulder circumferential ribs 20, 21.

In the central area 15 are, in this embodiment, three central (second) circumferential ribs 25, 26, 27 which extend along the circumferential direction of the tyre 1. Also in the central area 15 are, in this embodiment, three rows of central elements or blocks 25A, 26A, 27A arranged along the central circumferential ribs 25, 26, 27.

In this embodiment, the tyre equatorial plane passes through central circumferential rib 26, which is the circumferential rib that is positioned between the other two central circumferential ribs 25, 27.

In this embodiment, the tread band 2 has four circumferential grooves 30, 31, 32, 33 separating the shoulder ribs 20, 21 and central ribs 25, 26, 27 from another circumferential rib 20, 21, 25, 26, 27.

In the footprint area the width in the axial direction of each of the shoulder blocks 20A, 21A is greater than the width in axial direction of each of the central blocks 25A, 26A, 27A.

In addition, over the whole circumference of the tyre 1 the total number of shoulder blocks 20A, 21A in each row is greater than the total number of central blocks central blocks 25A, 26A, 27A in each row. This helps to balance stiffness at the shoulder with stiffness at the centre of the tyre, and to avoid rib “fighting”, and so reduce tyre wear. This arrangement can also reduce tyre noise by reducing synchronization of the impact of the central and shoulder elements with the road surface.

In this embodiment, the tyre 1 has 80 shoulder blocks 20A, 21A in each row, and 70 central blocks 25A, 26A, 27A in each row. However, this is not essential.

The shoulder blocks 20A, 21A are separated by lugs 40 extending substantially in the axial direction of the tyre 1.

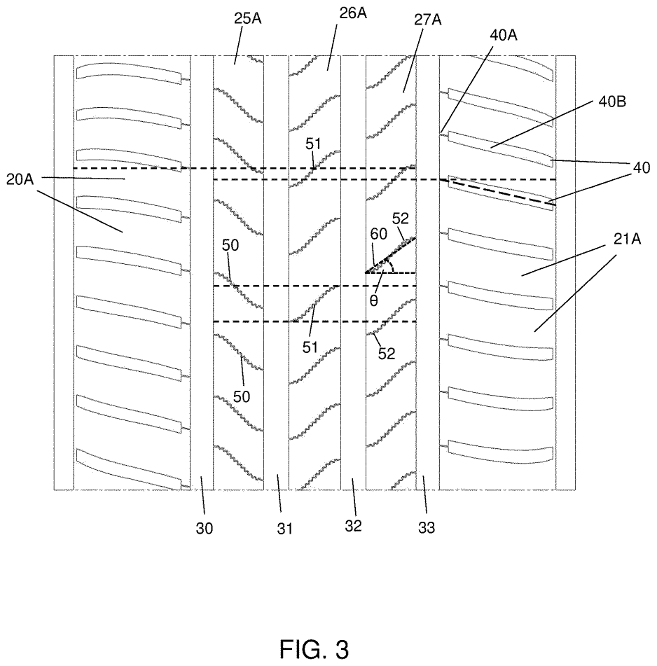

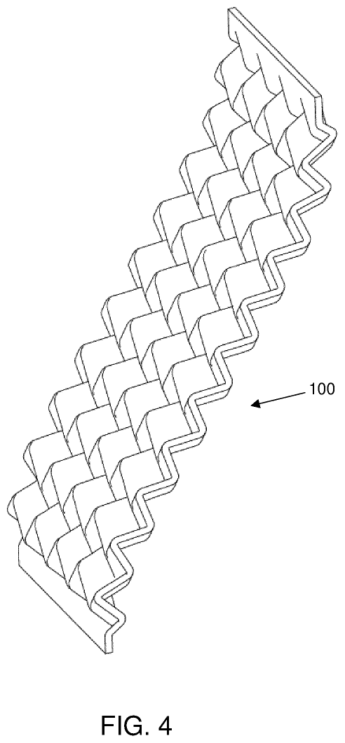

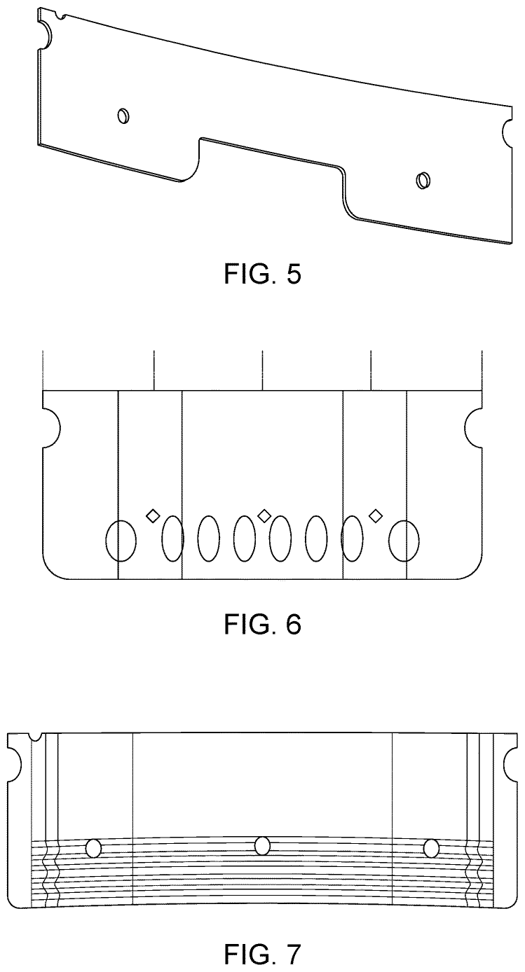

As best seen in FIG. 3, the lugs 40 have a width in the circumferential direction and have along their longitudinal extension a first portion 40A intersecting circumferential groove 33 and a second portion 40B extending from the first portion 40A outwards in the axial direction of the tyre 1. The width of the lugs 40 in the first portion 40A is smaller than the width of the lugs 40 in the second portion 40B. In particular, the width of the first portion 40A is small enough that the sidewalls of the first portion 40A are configured to touch each other when the first portion 40A passes through the contact patch of the tyre with the road surface. In this way, the first portion 40A is closed when it is in the contact patch, which helps to reduce the noise produced by impact of the blocks 20A, 21A on the road surface.

The central blocks 25A, 26A, 27A are separated along their entire axial width by transversal sipes 50, 51, 52. The transversal sipes 50, 51, 52 each define two endpoints at their respective axially outer ends where they intersect the circumferential grooves 30, 31, 32, 33.

An imaginary straight extension line 60 between the two endpoints defines an inclination angle θ of the transversal sipe 52 with respect to the axial direction of the tyre 1. The absolute value of angle θ lies in the range of 25° to 50°, and in this embodiment is 35°. The sipe is arranged in this way to improve lateral and circumferential connection of the central elements, which results in increased cornering performance and circumferential stiffness.

In FIG. 3 imaginary straight extension line 60 is shown with respect to a sipe 52 separating central blocks 27A. It can be seen that the sipe 51 which separates central blocks 26A is inclined in the same direction as sipe 52. However, it can be seen that sipe 50, which separates central blocks 25A is inclined in the opposite direction to sipes 51 and 52.

The sipes 50, 51, 52 do not extend in a straight line. This is done to improve lateral and circumferential connection of the central elements, which results in increased cornering performance and circumferential stiffness.

The extension along the axial direction between the two endpoints of the transversal sipes 50, 51, 52 is substantially S-shaped in plan view. The sipe is arranged in this way to improve lateral and circumferential connection of the central elements, which results in increased cornering performance and circumferential stiffness. This arrangement can also reduce tyre noise by leading to more progressive block impact with the road surface. Furthermore, an undulated profile (in the present embodiment, a zigzagged profile) is superimposed on the S-shaped extension along the axial direction of the transversal sipes 50, 51, 52 in plan view.

In the present embodiment, each endpoint of a transversal sipe 50, 51, 52 of each row of central blocks 25A, 26A, 27A has an offset in the circumferential direction with respect to each circumferential direction closest endpoint of a transversal sipe 50, 51, 52 of the adjacent row or rows. Taking the lower transversal sipe 51 of blocks 26A as an example, it can be seen in FIG. 3 that its endpoints are offset from the closest endpoints of sipes 50 of blocks 25A, and are also offset from the closest endpoints of sipes 52 of blocks 27A. This is shown by the dashed lines. Taking lower transversal sipe 52 of blocks 27A as another example, it can be seen in FIG. 3 that its endpoints are offset from the closet endpoints of sipes 51 which are in the adjacent row. In addition, one of the endpoints of lower sipe 52 (namely, its upper endpoint) is offset from the closest endpoint of upper sipe 50 which is in a non-adjacent row.

The transversal sipes 50, 51, 52 have a radial extension inside the tread band 2 along a radial profile which is undulated or zig-zag shaped as the sipes 50, 51, 52 extend in the axial direction.

In the present embodiment, the central blocks 25A, 26A, 27A are void of incisions, and are only separated by the transversal sipes 50, 51, 52. The central blocks 25A, 26A, 27A also have smooth radially outer surfaces.

In the present embodiment, the intersection between a lug 40 and a circumferential groove 30, 33 has an offset in the circumferential direction with respect to each circumferential direction closest endpoint of a transversal sipe 50, 51, 52 of each row of the central blocks 25A, 26A, 27A. This arrangement can reduce tyre noise by reducing synchronization of the impact of the central and shoulder blocks 25A, 26A, 27A, 20A, 21A with the road surface. Taking the lower lug 40 shown in FIG. 3 as an example, it can be seen that its intersection with circumferential groove 33 is offset from the endpoints of upper sipe 51 of blocks 26A. The intersection of lower lug 40 is also offset from the endpoints of each of the sipes 50, 52 of the other blocks 25A, 27A. In the present embodiment, this is the case for at least some of the lugs 40 in the right shoulder area shown in FIG. 3. This is also the case for at least some of the lugs 40 in the left shoulder area shown in FIG. 3.

As shown in the FIG. 3, the lower lug 40 extends in a substantially straight line. In addition, in this embodiment, although not essential, the inclination angle of the lugs 40 with respect to the axial direction of the tyre is less than the inclination angle of the imaginary straight extension line between the two endpoints of the transversal sipes 50, 51, 52. However, it is not essential that all lugs 40 and all transversal sipes 50, 51, 52 have this relationship, and it is possible that only some of the lugs 40 and transversal sipes 50, 51, 52 have this relationship. In this embodiment, although not essential, the inclination angle of the lugs 40 with respect to the axial direction of the tyre is about 15°.

In this embodiment there are three central circumferential ribs 25, 26, 27, three rows of central blocks 25A, 26A, 27A, and four circumferential grooves 30, 31, 32, 33. However, this is not essential, and the numbers of these ribs, rows and circumferential grooves may vary from this.

FIG. 4 shows a transversal sipe forming portion 100 of a mould for the tyre 1. The shape of the transversal sipe forming portion 100 corresponds to the sipes formed, for example sipes 50, 51 and 52. As can be seen in FIG. 4, as the undulated profile along the axial direction extends in the radial direction (i.e. in the depth direction of the sipe), another undulated profile is superimposed on the extension in the radial direction. In this way, the profile is undulated in two directions.

A preferred embodiment of the invention has been described purely by way of example, and various modifications, additions and/or omissions will present themselves to one skilled in the art, all of which form part of the invention.

In a particular embodiment, the tread band comprises two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib,
   wherein the central elements are separated along their entire axial width by transversal sipes, the transversal sipes defining two endpoints at their respective axially outer ends where they intersect the circumferential grooves;
wherein the extension along the axial direction between the two endpoints of the transversal sipes is substantially S-shaped, an undulated profile is superimposed on the S-shaped extension along the axial direction of the transversal sipes, the transversal sipes have a total length along their extension between the two endpoints and the total length of the transversal sipe having an undulated profile superimposed to the S-shaped extension is at least 20% greater than a transversal sipe extending along a straight line between the two endpoints and wherein the transversal sipes have a radial extension inside the tread band along a radial profile, wherein the radial profile is undulated or zig-zag shaped as the sipes extend in the axial direction,
wherein the tread band comprises and/or is prepared from:
(i) a first hydrocarbon polymer additive which is a partially hydrogenated C₅ resin; and,
(ii) a second hydrocarbon polymer additive which is a fully hydrogenated resin selected from the group consisting of a hydrogenated C₅ resin, a hydrogenated C₅/C₉ copolymer resin, a hydrogenated C₉ resin, and combinations thereof.

In a particular embodiment, the tread band comprises two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib, wherein the central elements are separated along their entire axial width by transversal sipes, the transversal sipes defining two endpoints at their respective axially outer ends where they intersect the circumferential grooves;
wherein the extension along the axial direction between the two endpoints of the transversal sipes is substantially S-shaped, an undulated profile is superimposed on the S-shaped extension along the axial direction of the transversal sipes, the transversal sipes have a total length along their extension between the two endpoints and the total length of the transversal sipe having an undulated profile superimposed to the S-shaped extension is at least 20% greater than a transversal sipe extending along a straight line between the two endpoints and wherein the transversal sipes have a radial extension inside the tread band along a radial profile, wherein the radial profile is undulated or zig-zag shaped as the sipes extend in the axial direction,
wherein the tread band comprises and/or is prepared from:
a hydrocarbon polymer additive component comprising:
   (i) a first hydrocarbon polymer additive, which is a partially hydrogenated C₅ resin, in an amount of from 1 to 30 phr; and,
   (ii) a second hydrocarbon polymer additive which is a fully hydrogenated C₉ resin, in an amount of from 1 to 30 phr;
   wherein the ratio of the amount of the first hydrocarbon polymer additive to the second hydrocarbon polymer additive is from 2:1 to 1:2.
a first styrene butadiene copolymer, which is functionalised with terminal carboxyl groups has a styrene content of from 21% to 24% by weight of the first styrene butadiene copolymer and is present in an amount of from 50 to 65 phr;
a second styrene butadiene copolymer having a styrene content of from 32 to 42% by weight of the second styrene butadiene copolymer and is present in an amount of from 20 to 30 phr;
a natural rubber in an amount of from 10 to 30 phr;
a first silica functionalised at its surface with one or more carboxyl groups and having a CTAB specific surface area of from 240 to 270 m²/g and/or a BET surface area of from 270 to 300 m²/g, present in an amount of from 60 to 70 phr; and,
a second silica having a CTAB specific surface area of from 65 to 95 m²/g, and/or a BET surface area of from 70 to 110 m²/g, present in an amount of from 10 to 20 phr.

Further features of the tread band of the present invention are described below.

The shoulder elements may be separated by lugs extending substantially in the axial direction of the tyre, and the lugs may have a width in the circumferential direction and have along their longitudinal extension a first portion intersecting a circumferential groove and a second portion extending outwards in the axial direction of the tyre, and the width of the lugs in the first portion intersecting the circumferential groove is smaller than the width of the lugs in the second portion.

In the footprint area the width in the axial direction of each of the shoulder elements may be greater than the width in axial direction of each of the central elements, and

wherein over the whole circumference of a tyre comprising the tread band the total number of shoulder elements in each row is greater than the total number of central elements in each row.

In the footprint area the void ratio of a shoulder area may be smaller than the void ratio of the central area by at least 3%.

The present invention will now be illustrated by the following non-limiting Examples.

### Examples

### Measurement Methods

### Elastic Modulus (E′)

The Elastic Modulus (E′) is used to evaluate grip performance. Dynamic physical testing to determine E at 30° C. is conducted in accordance with the ISO 4664 standard.

### Loss Factor (tan δ)

The loss factor (tangent δ, or tan δ) at different temperatures is used to evaluate rolling resistance and wet traction. Tan δ at lower temperatures is an indicator of wet traction. An increase in tan δ at lower temperatures, when compared to a control compound, correlates with an improvement in wet traction of the tread compound. When developing a rubber composition for a tyre tread to improve the rolling resistance of the tyre, it is typical to consider the loss tangent (tan δ) near 60° C. as an index. Use of a rubber composition with a low tan δ near 60° C. in the tread rubber can suppress heat build-up in the tyre to reduce rolling resistance and thus improve fuel efficiency of the tyre. Tan δ at 60° C. is thus an indicator of rolling resistance (RR). A lower result, when compared to a control compound, is indicative of decreased rolling resistance. Dynamic physical testing to determine tan δ is conducted in accordance with the ISO 4664 standard.

### Abrasion Resistance

Abrasion resistance is determined according to the ISO 4649 standard.

### Tyre Test

Tyre data are obtained from tests on cars fitted with tyres having tyre treads made using the rubber compositions. Three different tyre specifications are produced in which each specification differs only in the rubber tread compound—i.e. all other variables are kept constant. Cars are run for at least 10,000 km on a road surface and the extent of abrasion (in mm) is then measured (groove depth reduction).

### General Method

Tyre compounds were prepared according to the following general method. The following components were compounded in the amounts recited in Table 1 below.

### Components

Elastomers: Functionalised solution styrene-butadiene rubber (Fxt s-SBR 1) (prepared according to Example 3 of WO 2014/173706 A1)
   Solution-polymerised SBR (s-SBR) (EUROPRENE@SOL RX 74618)
   Natural rubber
   Emulsion-polymerised styrene-butadiene rubber (e-SBR) (EUROPRENE® 1739 BA, extended with 37.5 phr TDAE oil),
   Functionalised solution styrene-butadiene rubber (Fxt s-SBR 2) (EUROPRENE® SOL R 72616)
Silica: Functionalized very high surface area silica (Fxt VHSA-SiO₂) (prepared according to Example 6 in WO 2015/121333 A1)
   Silica (STD-SiO₂) (Ultrasil VN3)
   Very low surface area silica (VLSA-SiO₂) (ZEOSIL 1085GR)
Hydrocarbon polymer additive (resins):
   C₅ partially hydrogenated resin (C₅ resin)
   C₉ fully hydrogenated resin (C₉ Resin)
Further Additives:
   Carbon black (Corax@N234)
   Silane (Evonik Industries AG Si 69@)
   Octyl oleate
   Residual Aromatic Extract oil (RAE)
   Sulfur
   1,3-diphenyl guanidine (DPG)
   Dibenzothiazyl disulfide (MBTS)
   N-cyclohexyl-2-benzothiazyl sulfenamide (CBS)
   Zinc oxide (ZnO)
   Stearic acid.

TABLE 1

| | Compound A | Compound B | Compound C |
|---|---|---|---|
| Fxt s-SBR 1 | — | 57 | 57 |
| s-SBR | 34 | 43 | 23 |
| Natural Rubber | — | — | 20 |
| e-SBR | 32 | — | — |
| Fxt s-SBR 2 | 34 | — | — |
| Fxt VHSA SiO₂ | — | 64 | 64 |
| STD-SiO₂ | 70 | — | — |
| VLSA-SiO₂ | 20 | 16 | 16 |
| Carbon black | 5 | 2 | 2 |
| Silane | 6.1 | 9 | 9.5 |
| C₅ Resin | 5 | 8.5 | 8.4 |
| C₉ Resin | — | — | 8.4 |
| Octyl oleate | 5 | 7.2 | 4.1 |
| RAE | — | — | 3 |
| Sulfur | 1.2 | 0.6 | 0.6 |
| DPG | 0.5 | 2.2 | 1 |
| MBT | 0.8 | 1.6 | 1.6 |
| CBS | 1 | 0.9 | 0.7 |
| ZnO | 2 | 2 | 1 |
| Stearic acid | 1 | 1.5 | 1.5 |

Compound A solely contains the C₅ partially hydrogenated resin (C₅ resin), Compound B solely contains the C₉ fully hydrogenated resin (C₉ Resin) and Compound C contains both the C₅ resin and the C₉ resin.

The compounds of Table 1 were used to prepare tyre treads by extrusion, which would be known to the skilled person. The wear resistance, wet performance and rolling resistance of these tyres were measured using the methods described above. The results of these measurements are presented in Table 2 relative to Comparative Example 1, for which all the values of the listed properties have been normalised to 100. If the value of the viscoelastic property is greater than 100, an improvement in that property is indicated and, if the value of the property is less than 100, a reduction in that property is indicated.

TABLE 2

| Example No. | CEx 1 | CEx 2 | CEx 3 | CEx 4 | CEx 5 | Ex 1 |
|---|---|---|---|---|---|---|
| Sipe | 1^{st} alt. | 3rd alt. | 2nd alt. | 3rd alt. | 3rd alt. | 3rd alt. |
| | sipe | sipe | sipe | sipe | sipe | sipe |
| Compound | A | A | C | C | B | C |
| WEAR | 100 | 115 | 113 | 119 | 105 | 121 |
| WET | 100 | 98 | 105 | 104 | 108 | 107 |
| RRC | 100 | 100 | 104 | 104 | 104 | 104 |

The results in Table 2 demonstrate a significant improvement in performance (in particular wear resistance) when tyres having the third alternative (3^{rd} alt.) sipes of the present invention are prepared from a compound containing both the preferred C₅ resin and the C₉ resin. As can be seen from Table 2, tyres prepared from compound containing both the C₅ resin and the C₉ resin but which have sipes different from the third alternative one do not perform as well, and a tyre having the third alternative sipes but which is prepared from a compound containing only one of the resins also does not perform as well. This indicates a synergistic improvement when the C₅ resin and the C₉ resin are combined with the sipes of the present invention.

1. A tread band for a tyre suitable for engaging a road surface at a footprint area comprising: two shoulder areas at the axially outer ends of the tread band;
a central area identified between the shoulder areas;
a row of shoulder elements arranged along first circumferential ribs in each of the shoulder areas;
at least two rows of central elements arranged along second circumferential ribs in the central area; and
at least three circumferential grooves separating the first and second circumferential ribs from another circumferential rib, wherein the central elements are separated along their entire axial width by transversal sipes, the transversal sipes defining two endpoints at their respective axially outer ends where they intersect the circumferential grooves; and,
wherein the tread band further comprises:
(i) a first hydrocarbon polymer additive which is a partially hydrogenated C₅ resin; and,
(ii) a second hydrocarbon polymer additive which is a fully hydrogenated resin selected from the group consisting of a hydrogenated C₅ resin, a hydrogenated C₅/C₉ copolymer resin, a hydrogenated C₉ resin, and combinations thereof.

2. The tread band according to claim 1, wherein the first hydrocarbon polymer additive is a partially hydrogenated C₅ resin, and the second hydrocarbon polymer additive is a fully hydrogenated C₉ resin.

3. The tread band according to claim 1, wherein the first hydrocarbon polymer additive is a partially hydrogenated C₅ and dicyclopentadiene (DCPD) copolymer, preferably wherein DCPD is present in an amount of less than 5 wt % of the C₅ and DCPD monomers.

4. The tread band according to claim 1, wherein the first hydrocarbon polymer additive is a partially hydrogenated C₅ resin having one or more of the following features:
an olefinic proton content of less than 10 mol. %, preferably from 2 mol. % to 8 mol. %;
a softening point 110° C. or higher, preferably from 120° C. to 140° C.;
a weight average molecular weight of from 200 g/mol to 2000 g/mol, preferably from 800 g/mol to 1400 g/mol; and/or,
a glass transition temperature of 50° C. or higher, preferably from 60° C. to 90° C.

5. The tread band according to claim 1, wherein the second hydrocarbon polymer additive is a fully hydrogenated C₉ resin.

6. The tread band according to claim 1, wherein the hydrogenated C₉ resin has one or more of the following features:
a softening point of 100° C. or higher, preferably from 110° C. to 135° C.;
a weight average molecular weight of from 700 g/mol to 1500 g/mol; and/or,
a glass transition temperature of at least 50° C., preferably from 60° C. to 80° C.

7. The tread band according to claim 1, wherein the ratio of the amount of the first hydrocarbon polymer additive to the second hydrocarbon polymer additive is from 10:1 to 1:10, preferably from 5:1 to 1:5, more preferably from 2:1 to 1:2, even more preferably 1:1.

8. The tread band according to claim 1, wherein an imaginary straight extension line between the two endpoints defines an inclination angle of the transversal sipe with respect to the axial direction of the tyre whose absolute value lies in the range of 25° to 50°.

9. The tread band according to claim 8, wherein the extension along the axial direction between the two endpoints of the transversal sipes is substantially S-shaped, preferably wherein an undulated profile is superimposed on the S-shaped extension along the axial direction of the transversal sipes, more preferably wherein the transversal sipes have a total length along their extension between the two endpoints and the total length of the transversal sipe having an undulated profile superimposed to the S-shaped extension is at least 20% greater than a transversal sipe extending along a straight line between the two endpoints.

10. The tread band according to claim 1, wherein each endpoint of a transversal sipe of each row of central elements has an offset in the circumferential direction with respect to each circumferential direction closest endpoint of a transversal sipe of the adjacent row or rows.

11. The tread band according to claim 1, wherein the transversal sipes have a radial extension inside the tread band along a radial profile, wherein the radial profile is undulated or zig-zag shaped as the sipes extend in the axial direction.

12. The tread band according to claim 1, wherein the tread band further comprises a first elastomer component comprising one or more styrene-butadiene copolymers, preferably wherein the first elastomer component comprises a first styrene-butadiene copolymer and a second styrene-butadiene copolymer.

13. The tread band according to claim 12, wherein the first styrene-butadiene copolymer is functionalised with terminal carboxyl groups.

14. The tread band according to claim 12, wherein the first styrene-butadiene copolymer has a glass transition temperature ranging from −40 to −15° C., preferably −30 to −20° C.

15. The tread band according to claim 1, wherein the tread band further comprises a second elastomer component comprising natural rubber.

16. The tread band according to claim 1, wherein the tread band comprises a first silica, which is functionalised with one or more carboxyl groups.

17. The tread band according to claim 16, wherein the first silica has a CTAB specific surface area of from 230 to 285 m²/g.

18. The tread band according to claim 1, wherein the tread band comprises a second silica, preferably wherein the second silica has a CTAB specific surface area of 60 to 100 m²/g.

19. The tread band according to claim 1, wherein the tread band comprises:
a first styrene butadiene copolymer, which is functionalised with terminal carboxyl groups has a styrene content of from 21% to 24% by weight of the first styrene butadiene copolymer and is present in an amount of from 50 to 65 phr;
a second styrene butadiene copolymer having a styrene content of from 32 to 42% by weight of the second styrene butadiene copolymer and is present in an amount of from 20 to 30 phr;
a natural rubber in an amount of from 10 to 30 phr;
a first silica functionalised at its surface with one or more carboxyl groups and having a CTAB specific surface area of from 240 to 270 m²/g and/or a BET surface area of from 270 to 300 m²/g, present in an amount of from 60 to 70 phr; and,
a second silica having a CTAB specific surface area of from 65 to 95 m²/g, and/or a BET surface area of from 70 to 110 m²/g, present in an amount of from 10 to 20 phr.

20. A pneumatic tyre comprising the tread band according to claim 1.
